(19) United States
(12) Patent Application Publication
(10) Pub. No.: US 2016/0234416 A1
(43) Pub. Date: Aug. 11, 2016

(54) METHOD, DEVICE, AND SELF SERVICE EQUIPMENT THEREOF FOR CARD PROCESSING IN CARD READER

(71) Applicant: GRG Banking Equipment Co., Ltd., Guangzhou, Guangdong (CN)

(72) Inventors: Dahai Xiao, Guangzhou, Guangdong (CN); Xiaoming Ouyang, Guangzhou, Guangdong (CN); Qinghua Wang, Guangzhou, Guangdong (CN); Xuewen Dong, Guangzhou, Guangdong (CN); Rong Yong, Guangzhou, Guangdong (CN); Wanqi Huang, Guangzhou, Guangdong (CN)

(73) Assignee: GRG Banking Equipment Co., Ltd., Guangzhou, Guangdong (CN)

(21) Appl. No.: 15/021,861

(22) PCT Filed: Feb. 18, 2014
(86) PCT No.: PCT/CN2014/072174

§ 371 Date: Mar. 14, 2016

(30) Foreign Application Priority Data
Sep. 16, 2013 (CN) 201310422178.0

(51) Int. Cl. H04N 5/235; G06T 7/00

(52) U.S. Cl. CPC H04N 5/2351; H04N 5/2353; G06T 7/0018

(57) ABSTRACT

A method, device, and self service equipment for card processing in a card reader. When a card is detected in a card reader, a card processing opening of the card reader is continuously detected for the presence or absence of a card, then, once the presence of a card is detected at the card processing opening, a user is prompted and warned that the card may have been switched, while at the same time, a currently ongoing service is suspended, the user is required to perform an identity authentication, a self service interface is switched to an interface to wait for the user to enter a password, and, only when the user correctly enters the password within a prescribed time, will processing of the current service be continued.

### CROSS REFERENCE TO RELATED APPLICATION

The present application claims the priority to Chinese Patent Application No. 201310422178.0, titled “METHOD, DEVICE, AND SELF SERVICE EQUIPMENT THEREOF FOR CARD PROCESSING IN CARD READER”, filed on Sep. 16, 2013 with the State Intellectual Property Office of the People's Republic of China, the entire content of which is incorporated herein by reference.

### TECHNICAL FIELD

The present disclosure relates to the technical field of financial self-service terminals, in particular to a method and a device for processing a card in a card reader and a self-service device thereof.

### BACKGROUND

An ATM (Automated Teller Machine, ATM) is a common financial self-service device in the daily life. For most self services implemented on a self-service device, such as depositing with a card, withdrawing with a card, check, password modification and transfer, a bank card is needed. During a self service, it should be ensured by a user that at least one of bank card information and password information is not leaked. For example, during the self-service, it should be ensured by the user that an operating right is not obtained by others after a password is correctly entered and before the bank card is returned. A conventional self-service device can not effectively solve the above problem, and may encounter the following problem.

In a case that the user is about to use the self service, he or she needs to insert the card into a card reader and enter the password, and then transactions can be conducted on an interface. In a transaction process, a criminal may insert a counterfeit card into a card processing slot of the card reader to pass it off as the real card of the user, and then lie to the user that the service is completed and the card is returned. In this case, the user may mistakenly think that his or her card is returned since there is indeed a card in the card processing slot of the card reader, and leave the self-service device with the counterfeit card, willingly or not. Actually, the card of the user remains in the card reader, so that the criminal can continue the transactions to withdraw cash in the card of the user since the password has been correctly entered by the user. As described above, in a case that a card is inserted in the card processing slot of the card reader when there is already a card in the card reader of the self-service device, the self-service device provides no prompt and takes no action. At present, by utilizing such a feature of the self-service device, the criminal can substitute the bank card when the business is used by the user, so as to steal the cash in the bank card of the user, which causes a security risk to the self-service device.

Therefore, the conventional self-service device needs to be improved, so as to effectively prevent the bank card of the user from being substituted, thereby preventing a business operating right from being obtained by the criminal which causes a security risk to the cash in the card of the user.

### SUMMARY

The present disclosure is to provide a method and a device for processing a card in a card reader and a self-service device, so as to facilitate a user to see through a fraud of stealthily substituting a bank card in time, and to prevent a business operating right from being obtained by others, when a business operation is carried out by the self-service device for the user, thereby increasing the security and the intelligence of the self-service device and ensuring the security of user property.

To achieve the above object, the following technical solutions are provided according to the present disclosure.

A method for processing a card in a card reader, applied to a self-service device, including:

detecting a state of the card reader in a realtime manner, when the card is used by a user to carry out a business transaction;

generating, by the card reader, an event that there is a card in a card entrance slot, and sending the event to a self-service business system in a realtime manner, once a card is detected in a card processing slot of the card reader, so as to enable the self-service business system to provide warning information, suspend a current business and enter a procedure of user authentication; and

continuing the current business, in a case that the user authentication performed in a preset period of time is successful.

Specifically, a function of detecting the card in the card processing slot implemented by a second detection module of the card reader may be realized by a module for detecting a magnetic signal or a module for detecting a presence of a card which is provided by a detection device in the card reader, or be realized by a device in the card reader for detecting a foreign body in the card processing slot.

Specifically, the warning information may be generated by the card reader based on results of two detection modules of the card reader, or be generated by the self-service business system based on the detection results of the two detection modules sent by the card reader.

Specifically, the user authentication may require the user to re-enter a password or biometric information such a fingerprint, or other well known means of authenticating the user which are provided by the self-service business system, such as mobile phone verification and USB key verification.

A device for processing a card in a card reader, applied to a self-service device, including:

a first detection module and a second detection module, configured to detect whether there is a card in each of the interior of the card reader and a card entrance slot, and send a detection result to a determining and analyzing module;

the determining and analyzing module, configured to receive the detection result of the first detection module and the second detection module, and send warning information to a self-service business system and a warning module respectively in a case that each of the first detection module and the second detection module detects a card when a business operation is carried out by the self-service business system;

the warning module, configured to convey the warning information to the user by means of screen displaying or voice prompting;

the self-service business system, configured to receive the warning information, suspend a current business and call a user authentication module to perform user authentication; and

the user authentication module, configure to perform a procedure of the user authentication, and send information to the self-service business system to allow the self-service business system to continue the current business in a case that the user authentication is successful, or, allow the self-service business system to terminate the current business to return or retain the card in a case that the user authentication performed by the user authentication module in a preset period of time is not successful.

It can be seen from the above technical solutions that, based on the method and the device for processing the card in the card reader and the self-service device, it is constantly detected whether there is a card in the card processing slot of the card reader when a card is already detected in the card reader; in a case that a card is detected in the card processing slot, the user is prompted with a warning to avoid that the card is substituted, the current business is suspended, the user is required to perform the user authentication, and an interface of a self service is switched to an interface on which the password is to be entered; and the current business may be continued in a case that the password is correctly entered by the user in the preset time. The above solutions can effectively avoid the following situation: when the self service is used by the user, the criminal may insert a counterfeit card into the card reader to pass it off as the card of the user, so as to trick the user into handing over the business operating right which causes a financial loss to the user. The security of the self service is increased according to the present solutions.

### BRIEF DESCRIPTION OF THE DRAWINGS

In order to more clearly illustrate technical solutions in embodiments of the present disclosure or in the conventional technology, drawings used in the description of the embodiments or the conventional technology are introduced briefly hereinafter. Apparently, the drawings described in the following illustrates some embodiments of the present disclosure, other drawings may be obtained by those ordinarily skilled in the art based on these drawings without any creative efforts.

FIG. 1 is a flow chart of a method for processing a card in a card reader according to an embodiment of the present disclosure;

FIG. 2 is a schematic structural diagram of a device for processing a card in a card reader according to an embodiment of the present disclosure;

FIG. 3 is a flow chart of switching two operation modes of a device in a card reader for detecting a foreign body according to an embodiment of the present disclosure; and

FIG. 4 is a flow chart of a method for controlling switching of operation modes of a device in a card reader for detecting a foreign body according to an embodiment of the present disclosure.

### DETAILED DESCRIPTION

The technical solutions in embodiments of the present disclosure are clearly and completely described hereinafter in conjunction with the drawings in the embodiments of the present disclosure. Apparently, the described embodiments are only a few of the embodiments of the present disclosure. Based on the embodiments of the present disclosure, all other embodiments obtained by those ordinarily skilled in the art without any creative efforts fall within the protection scope of the present disclosure.

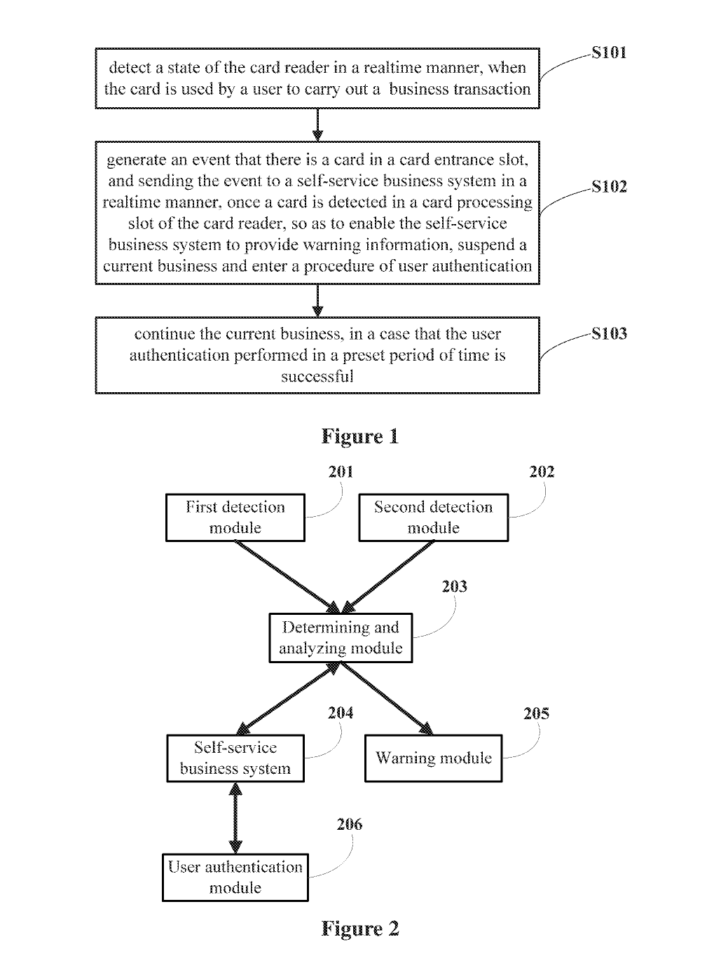

Reference is made to FIG. 1, which illustrates a flow chart of a method for processing a card in a card reader according to an embodiment of the present disclosure. The steps of the method are described as follows.

In step S101, a state of the card reader is detected in a realtime manner, when the card is used by a user to carry out a business transaction.

When the card is used by the user for the self service, if the card is in the card reader, the self-service device operates in a normal service state. A case that the card in the card reader is not returned or is retained due to a failure in the card reader, i.e., a case that the self-service device does not operate in the normal service state, is not taken into account by the present solutions.

According to the conventional technology, when the self-service device operates in the service state and there is a card in the card reader, an event that there is a card or a foreign body in a card processing slot will not be sent to a self-service business system or be processed by the card reader in a case that the card or the foreign body is detected in the card processing slot of the card reader. In practice, when a self service is used by the user, a criminal may insert a counterfeit card into the card processing slot of the card reader to trick the user into handing over a business operating right. In the conventional technology, the self-service device provides no prompts to the user, and takes no security measures to ensure the security of capital in an account of the user.

Preferably, in order to detect whether there is a card in a card entrance slot of the card reader, a means of using a card processing function provided by a hardware component of the card reader which accepts the card based on a presence of the card or based on a magnetic signal of the card may be used, and an event that a card is detected in the card entrance slot may be sent to the self-service business system by the card reader immediately.

In addition, in order to detect whether there is a card in a card entrance slot of the card reader, a means of using a foreign body detection function of the card reader may be used. Compared with the conventional technology, the improvement is that an event that a foreign body is detected is sent to the self-service business system by the card reader immediately after the foreign body is detected by the card reader during the business. In the conventional technology, it may take a long time (such as longer than 5 minutes) to detect the foreign body. In the conventional technology, it may take a long time (such as longer than 5 minutes) to detect the foreign body, which is to avoid temporary disruption such as inserting another card, and a device for detecting the foreign body which is arranged at the card entrance slot of the card reader is to detect whether there is a card stealing device for stealing information of the card at the card entrance slot of the card reader.

In step S102, the event that there is a card in the card entrance slot is generated, and the event is sent to the self-service business system in a realtime manner, once the card is detected in the card processing slot of the card reader, so as to enable the self-service business system to provide warning information, suspend a current business and enter a procedure of user authentication.

When the business is operated by the user, once a card is detected in the card entrance slot of the card reader, the event is sent to the self-service business system by the card reader in time and the user is reminded by the self-service business system in time to prevent the card from being substituted, so as to avoid the following situation: when the business is operated by the user, the criminal may insert the counterfeit card into the card entrance slot of the card reader to pass it off as the card of the user, so as to trick the user into handing over the business operating right.

The providing warning information includes reminding the user to prevent the card from being substituted and so on, and may be implemented by means of screen displaying or voice prompting.

The current business is suspended by the self-service business system and the procedure of the user authentication is started. In a case that an operation result of the current business will not cause a change to the capital in the account of the user or a password of the user, for example, in a case that the current business is a check business, the procedure of the user authentication may be started after the business is completed or a predetermined time limit is exceeded by the current business. In a case that an operation result of the current business will cause a change to the capital in the account of the user or the password of the user, for example, in a case that the current business is a password modification business or a transfer business, the current business is suspended immediately and the procedure of the user authentication is started.

In step S103, the current business is continued in a case that the user authentication performed in a preset period of time is successful.

It should be noted that, in a case that the user authentication is not successful, the current business is terminated by the self-service business system, and the business is ended by returning or retaining the card.

Specifically, for the user authentication described above, if the password is not entered by the user in the preset time or the password is mistakenly entered for three times, the current business is terminated and the card is returned or retained.

Specifically, for the terminating the business described above, in a case that an amount of capital is successfully deducted from the account and banknotes do not come out during a withdrawing business, a process of reverse of withdrawing needs to be started to balance the account. In a case that banknote counting is not finished during a depositing business, banknotes are retained and are not conveyed to a banknote outlet.

Reference is made to FIG. 2, which is a schematic structural diagram of a device for processing a card in a card reader according to an embodiment of the present disclosure, corresponding to the method embodiment. The device includes: a first detection module 201, a second detection module 202, a determining and analyzing module 203, a self-service business system 204, a warning module 205 and a user authentication module 206.

The first detection module 201 and the second detection module 202 are configured to detect whether there is a card in the interior of the card reader and whether there is a card in a card entrance slot respectively, and send a detection result to the determining and analyzing module 203. In a case that the detection result received by the determining and analyzing module 203 indicates that each of the first detection module 201 and the second detection module 202 detects a card when a business operation is carried out by the self-service business system, warning information is sent to the self-service business system 204 and the warning module 205 respectively by the determining and analyzing module 203. The warning information is conveyed to a user by means of screen displaying or voice prompting by the warning module 205. Once receiving the warning information, the self-service business system 204 suspends a current business and calls the user authentication module 206 to perform user authentication. The user enters his or her identity information via the user authentication module 206. Information is sent to the self-service business system 204 to allow the self-service business system 204 to continue the current business in a case that the user authentication performed by the user authentication module 206 is successful. The self-service business system 204 terminates the current business to return or retain the card in a case that the result that the user authentication module 206 performs the user authentication in a preset time is not successful.

The second detection module 202 may be a module with a card processing function provided by a hardware component of the card reader which accepts a card based on a presence of the card or based on a magnetic signal of the card, or a functional module in the card reader for detecting a foreign body.

Preferably, the user authentication module 206 may be a functional module which requires the user to re-enter a password of an account to perform the user authentication.

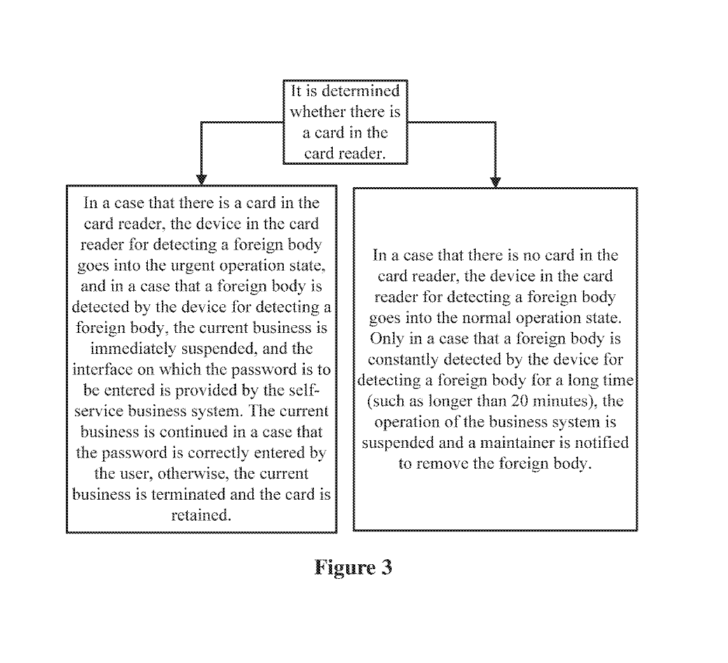

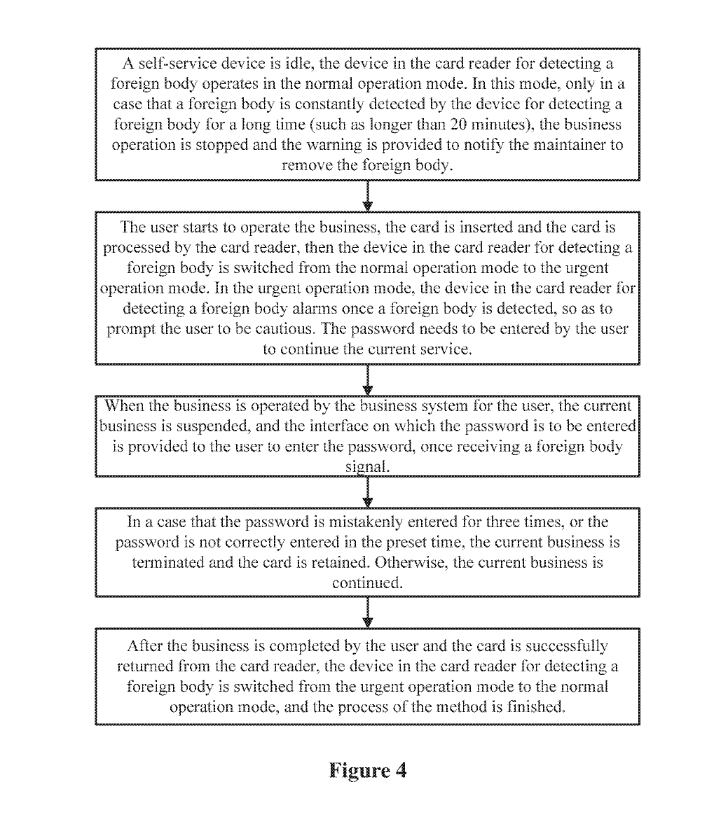

FIG. 3 and FIG. 4 illustrate a method for processing a card with a device in a card reader for detecting a foreign body.

A conventional device in a card reader for detecting the foreign body is developed to avoid that a card stealing device is added to the card reader by a criminal to illegally obtain information of the card of a user. The device in the card reader for detecting the foreign body alarms and determines that the card reader is sheltered by the foreign body only in a case that the foreign body is constantly detected for a long time (such as half an hour, and preferably longer than time required for operating a business). The device in the card reader for detecting the foreign body does not alarm in a case that the foreign body is constantly detected for a short time. For example, if the card is being returned, there is a timeout about 2 to 3 minutes for taking away the card, after the card is returned to a card taking slot and before the card is retained. It is detected by device in the card reader for detecting the foreign body that there is a foreign body in the card taking slot during the timeout. In fact, in this case, the card is accepted or returned normally, so that no warning information is sent, and no signal which indicates that there is an abnormality in the card reader is sent to the self-service business system.

In the embodiment, when the business is operated by the user, in a case that the card of the user is in the card reader and a foreign body is detected by the device in the card reader for detecting the foreign body, a warning is generated. And the user is required to re-enter a password if the card in the card reader is used to operate a withdrawing business or a transfer business. In this case, based on the warning, the user is prompted to be cautious and a criminal is deterred; based on requiring the user to re-enter the password to carry out a cash transaction, the security of capital of the user is ensured, and no loss is caused even if the user is tricked. That is, as long as the card is in the card reader, when another card is inserted into a specially shaped slot, the password needs to be re-entered if the card in the card reader is used to carry out the cash transaction, which ensures the security of the capital of the user even if the card is substituted.

The method for processing a card based on a foreign body detection function of the card reader according to the embodiment may include the following steps.

1) If a foreign body is detected by the device in the card reader for detecting the foreign body, then the process of the method goes to step 2) in a case that there is a card in the card reader; otherwise, the process of the method is finished with no processing.

2) In a case that the current business is a withdrawing business or a transfer business, the current business is suspended, an interface on which the password is to be entered is provided. The current business is continued and the process of the method is finished if the password is correctly entered by the use in a preset time; otherwise, the process of the method goes to step 3).

3) In a case that the current business is not the withdrawing business or the transfer business, the current business is continued. The user is required to re-enter the password if the card in the card reader is used to operate the withdrawing business or the transfer business, and the current business is continued and the process of the method is finished if the password is correctly entered by the use in a preset time.

Preferably, during the business, if a state of the device for detecting the foreign body is switched from a state in which no foreign body is detected to a state in which a foreign body is detected, then a security control system according to the present solutions will work.

In the embodiment, operation states of the device in the card reader for detecting the foreign body are divided into two types: a normal operation mode and an urgent operation mode.

The normal operation mode refers to an operation state in which a foreign body in the card reader is detected in the conventional technology. If the device for detecting the foreign body operates in this state, a signal is not immediately sent to a monitoring system and the self-service business system to report that there is a foreign body in the card reader in a case that a foreign body is detected in the card reader. Only if a foreign body is constantly detected for a long time, such as 20 minutes or even much longer, it can be determined by the monitoring system of a self-service terminal that a foreign body is added to the card reader. The cumulative time needs to be reset and recounted once the foreign body disappears. Therefore, normal cases in which a foreign body is detected can be identified: a case that a foreign body is detected by the device for detecting the foreign body due to a bank card temporarily passing a card entrance or exit slot, which is caused by inserting the card, processing the card, returning the card or taking away the card when the business is operated by the user.

The urgent operation mode is a newly added operation state according to the present solutions. If the device for detecting the foreign body operates in this state, in a case that a foreign body is detected in the card reader, a signal is immediately sent to the self-service business system to report that there is a foreign body in the card reader, and the self-service business system suspends the current business and goes into an emergency processing mode.

A precondition for the device in the card reader for detecting the foreign body to operate in this operation state is that there is already a bank card in the card reader to carry out a business operation. After the password is correctly entered by the user, the device for detecting the foreign body starts to operate in this operation state, until the business is completed and the card is successfully returned.

In the embodiment, a process of switching the two operation modes of the device in the card reader for detecting the foreign body is as follows.

1) It is determined whether there is a card in the card reader.

2) In a case that there is a card in the card reader, the device in the card reader for detecting the foreign body goes into the urgent operation state. And in a case that a foreign body is detected by the device for detecting the foreign body, the current business is immediately suspended, and the interface on which the password is to be entered is provided by the self-service business system. The current business is continued in a case that the password is correctly entered by the user, otherwise, the current business is terminated and the card is retained.

3) In a case that there is no card in the card reader, the device in the card reader for detecting the foreign body goes into the normal operation state. Only in a case that a foreign body is constantly detected by the device for detecting the foreign body for a long time (such as longer than 20 minutes), the operation of the business system is suspended and a maintainer is notified to remove the foreign body.

In the embodiment, a process of a method for controlling switching of foreign body detection of a card reader is as follows.

1) A self-service device is idle and no business is being performed, the device in the card reader for detecting the foreign body operates in the normal operation mode. In this mode, only in a case that a foreign body is constantly detected by the device for detecting the foreign body for a long time (such as longer than 20 minutes, which may be set based on an actual situation), the business operation is stopped and the warning is sent to notify the maintainer to remove the foreign body.

The warning is sent in a case that a foreign body is constantly detected for a long time, instead of being sent immediately after a foreign body is detected. This is due to requirements of normal business operations such as inserting the card and taking away the card. During these business operations, a foreign body may also be detected, which is because of normal operation.

When the device in the card reader for detecting the foreign body operates in the operation mode, the warning is provided to notify the maintainer. In this case, the device for detecting the foreign body alarms due to the fact that the card stealing device which can steal the information of the card of the user may be added to the card reader by the criminal. Then the maintainer may remove the foreign body.

2) The user starts to operate the business, the card is inserted and the card is processed by the card reader. Then the device in the card reader for detecting the foreign body is switched from the normal operation mode to the urgent operation mode. In the urgent operation mode, the device in the card reader for detecting the foreign body alarms once a foreign body is detected, so as to prompt the user to be cautious. The password needs to be entered by the user to continue the current business.

When the device in the card reader for detecting the foreign body operates in the urgent mode, the warning is provided to notify the user that operates the self service, instead of notifying the maintainer. In this case, the device for detecting the foreign body alarms due to the fact that a foreign body such as a counterfeit card may be inserted in the card processing slot of the card reader to trick the user and disturb operations of the user, and not due to the fact that the card stealing device which can steal the information of the card of the user may be added.

3) When the business is operated by the business system for the user, the current business is suspended, and the interface on which the password is to be entered is provided to the user to enter the password, once receiving a foreign body signal.

When the device in the card reader for detecting the foreign body operates in the urgent mode, the user is required to re-enter the password to continue the current business. In this case, even if the user is tricked into leaving the self-service device, the card can not be used by other people to carry out a business, which ensure the security of the capital of the user.

4) In a case that the password is mistakenly entered for three times, or the password is not correctly entered in a preset time, the current business is terminated and the card is retained. In a case that the password is correctly entered by the user, the current business is continued.

5) After the business is completed by the user and the card is successfully returned from the card reader, the device in the card reader for detecting the foreign body is switched from the urgent operation mode to the normal operation mode, and the process of the method is finished.

It can be understood by those skilled in the art that, drawings are only used to illustrate the embodiments, units or processes according to the drawings are not necessary for the embodiments of the present disclosure.

It should be understood that the disclosed systems, devices and methods according to some embodiments of the present disclosure may be implemented in other ways. For example, the device embodiments described above are illustrative only. For example, the unit division is merely logical function division and may be other division in actual implementation. For example, multiple units or components may be combined or integrated into another system, or some features may be ignored or not performed. In addition, the displayed or discussed mutual couplings, direct couplings or communication connections may be implemented via some interfaces. The indirect couplings or communication connections between the devices or units may be implemented in electronic, mechanical or other forms.

The units described as separate parts may or may not be physically separate, and parts displayed as units may or may not be physical units, which may be located in one position or distributed on multiple network units. A part or all of the units may be selected to achieve the object of solutions in the embodiments of the present disclosure based on practical requirements.

In addition, the functional units in the embodiments of the present disclosure may be integrated into a processing unit, or be separately included in units, or, two or more units may be integrated into a unit. The above integrated unit may be implemented in a hardware form or a form of a combination of hardware and a software functional unit.

The above integrated unit implemented in the form of the software functional unit may be stored in a computer readable storage medium. The above software functional unit is stored in a storage medium which includes several instructions to make a computer device (which may be a personal computer, a server or a network device, etc.) to execute all or some of the steps in the methods according to the embodiments of the present disclosure. The above storage medium may be a USB flash disk, a mobile hard disk, a read-only memory (Read-Only Memory, ROM), a random access memory (Random Access Memory, RAM) or other medium that can store program codes such as an optical disk or a magnetic disk.

Finally, it should be noted that, the above embodiments are only used to illustrate the technical solutions of the present disclosure, and are not used to limit the present disclosure. Although the present disclosure is illustrated in detail according to the above embodiments, it should be understood by those ordinarily skilled in the art that, various modifications to the technical solutions of the above embodiments can be made by them or some of the technical features can be substituted with equivalents, these modifications or substitutions do not make the essence of corresponding technical solutions depart from the spirit or scope of the technical solutions of the embodiments of the present disclosure.

1. A method for image calibration comprising:
S1: obtaining, for each of photosensitive elements, a high lighting parameter corresponding to a long exposure time and a low lighting parameter corresponding to a short exposure time;
S2: obtaining image data of a sheet medium; and
S3: calculating calibrated image data of the sheet medium based on the high lighting parameter, the low lighting parameter and the image data,

2. The method for image calibration according to claim 1, wherein the step S1 comprises:
S11: obtaining, for each of the photosensitive elements, the high lighting parameter corresponding to the long exposure time; and
S12: obtaining, for each of the photosensitive elements, the low lighting parameter corresponding to the short exposure time; or.
S11: obtaining, for each of the photosensitive elements,the low lighting parameter corresponding to the short exposure time; and
S12: obtaining, for each of the photosensitive elements, the high lighting parameter corresponding to the long exposure time.

3. The method for image calibration according to claim 2, wherein the process of obtaining, for each of the photosensitive elements, the high lighting parameter corresponding to the long exposure time comprises:
performing a long time exposure on a gray scale board for a period of tH;
recording image data IHi obtained through the long time exposure and a corresponding gray value GrayH; and
storing the image data IHi and the gray value GrayH.

4. The method for image calibration according to claim 3, wherein the process of obtaining, for each of the photosensitive elements, the low lighting parameter corresponding to the short exposure time comprises:
performing a short time exposure on the gray scale board for a period of tL;
recording image data ILi obtained through the short time exposure and a corresponding gray value GrayL; and
storing the image data ILi and the gray value GrayL.

5. The method for image calibration according to claim 4, wherein:
the period tH is 60 us, and the gray value GrayH is 200; and
the period tL is 10 us, and the gray value GrayL is 20

6. The method for image calibration according to claim 4, wherein the step S3 comprises:
reading the image data IHi, the gray value GrayH, the image data ILi and the gray value GrayL; and
denoting the image data obtained in the step S2 as Xi, and denoting the calibrated image data as Xi′, then
Xᵢ′=GrayL+(GrayH−GrayL)*(Xᵢ−ILᵢ)/(IHᵢ−ILᵢ).

7. The method for image calibration according to claim 4, wherein after the step S1 and before the step S3, the method further comprises:
storing the high lighting parameter and the low lighting parameter.

8. A device for image calibration comprising:
a first obtaining unit, configured to obtain for each of photosensitive elements a high lighting parameter corresponding to a long exposure time and a low lighting parameter corresponding to a short exposure time;
a second obtaining unit, configured to obtain image data of a sheet medium; and
a calculating unit, configured to calculate calibrated image data of the sheet medium based on the high lighting parameter, the low lighting parameter and the image data.

9. The device for image calibration according to claim 8, further comprising:
a storing unit, configured to store the high lighting parameter and the low lighting parameter.

10. A device for image calibration comprising:
an image sensing unit, configured to collect image information of a medium;
a storing unit, configured to store the image information, and a controlling parameter and an image processing parameter of the image sensing unit; and
a controlling and processing unit, configured to control a device for image calibration, calculate deviation compensation coefficients based on the controlling parameter and the image processing parameter, and calibrate data of each image pixel, collected and outputted by the image sensing unit, based on the deviation compensation coefficients.

11. The method for image calibration according to claim 5, wherein the step S3 comprises:
reading the image data IHi, the gray value GrayH, the image data ILI and the gray value GrayL; and
denoting the image data obtained in the step S2 as Xi, and denoting the calibrated image data as Xi′, then
Xᵢ′−GrayL+(GrayH−GrayL)*(Xᵢ−ILᵢ)/(ILᵢILᵢ).

12. The method for image calibration according to claim 5, wherein after the step S1 and before the step S3, the method further comprises:
storing the high lighting parameter and the low lighting parameter.
